(19) United States
(12) Patent Application Publication
(10) Pub. No.: US 2021/0112336 A1
(43) Pub. Date: Apr. 15, 2021

(54) Sound Source Localization and Sound System

(71) Applicant: U-MEDIA Communications, Inc., Hsinchu (TW)

(72) Inventor: Yu-Chuan Chen, Nantou County (TW)

(21) Appl. No.: 16/709,933

(22) Filed: Dec. 11, 2019

(30) Foreign Application Priority Data
Oct. 9, 2019 (TW) 108136524

(51) Int. Cl. H04R 3/00; G01S 5/22; H04R 1/40; G01S 3/808

(52) U.S. Cl. CPC H04R 3/005; G01S 5/22; G10L 2021/02166; G01S 3/8083; H04R 1/406

(57) ABSTRACT

A sound source localization method, applied in a sound system comprising a microphone array, is provided. The sound source localization method comprises the microphone array receiving a received signal; building a cost function according to the received signal; forming a plurality of particles, wherein the plurality of particles is a plurality of virtual particles; computing a plurality of update positions of the plurality of particles according to a plurality of current positions and the cost function, and obtaining at least a sound source location according to the plurality of update positions.

### BACKGROUND OF THE INVENTION

### 1. Field of the Invention

The present invention relates to sound source localization method and a sound system, and more particularly, a low computational complexity, high accuracy sound source localization method and a sound system.

### 2. Description of the Prior Art

Sound source localization is an important technology in the field of sound signal processing. In the operation of sound source separation or reducing environmental noise interference, it is very helpful for the performance of sound separation or noise cancellation with the position information of the target or the interference source. In addition, in voice-related processing applications, the location of the sound source is also an important piece of information to the system, such as confirming the position of the speaker in the video conference or identifying the direction of the talker of the smart robot. Generally, the more accurate sound source localization system requires a microphone array of different positions in the space is arranged in a certain manner by a plurality of microphones. Due to its spatial selectivity, the microphone array may implement the sound source localization within a certain range.

The multiple signal classification (MUSIC) algorithm is a commonly used sound source localization method. However, the MUSIC algorithm is in high computational complexity, and the sound source cannot be localized accurately.

Therefore, it is necessary to improve the prior art.

### SUMMARY OF THE INVENTION

It is, therefore, a primary objective of the present invention to provide a low computational complexity and high accuracy sound source localization method and a sound system to improve over disadvantages of the prior art.

An embodiment of the present invention discloses a sound source localization method, applied to a sound system, the sound system comprising a microphone array, the method comprising the microphone array receiving a received signal; establishing a cost function according to the received signal; forming a plurality of particles, wherein the plurality of particles are a plurality of virtual particles, and computing a plurality of update positions of the plurality of particles according to a plurality of current positions of the plurality of particles and the cost function, and obtaining at least one sound source locations according to the plurality of update positions.

An embodiment of the present invention further discloses a sound system, comprising a microphone array, comprising a plurality of microphone, configured to receive a received signal, and a sound source localization module, configured to perform the following steps: establishing a cost function according to the received signal; forming a plurality of particles, wherein the plurality of particles are a plurality of virtual particles, and computing a plurality of update positions of the plurality of particles according to a plurality of current positions of the plurality of particles and the cost function, and obtaining at least one sound source locations according to the plurality of update positions.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a sound system 10 in an embodiment of the present invention.

FIG. 2 is a schematic diagram of a sound source localization process in an embodiment of the present invention.

FIG. 3 is a schematic diagram of a uniform linear array.

FIG. 4 is a schematic diagram of a uniform circular array.

FIG. 5 is a schematic diagram of a process in an embodiment of the present invention.

FIG. 6 is a schematic diagram of a 2-dimensional space.

FIG. 7 is a schematic diagram of a process in an embodiment of the present invention.

### DETAILED DESCRIPTION

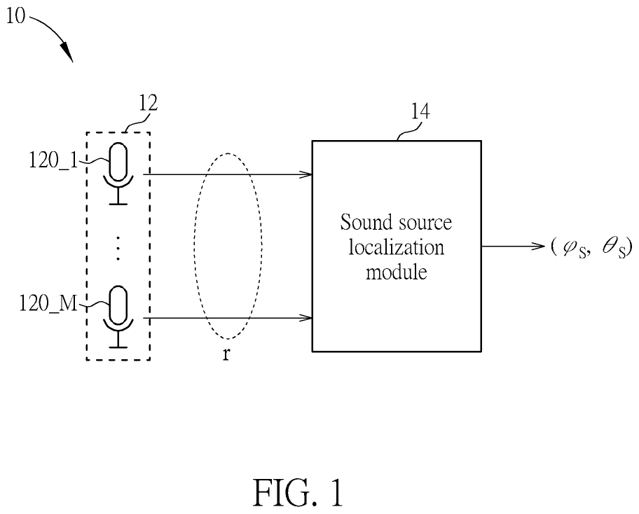

FIG. 1 is a schematic diagram of a sound system 10 according to an embodiment of the present invention. The sound system 10 comprises a microphone array 12 and a sound source localization module 14. The microphone array 12 comprises a plurality of microphones 120_1-120_M, which may be arranged in a circular array or a linear array, and not limited thereto. In an embodiment, the sound source localization module 14 may be implemented by an application-specific integrated circuit (ASIC). In an embodiment, the sound source localization module 14 may comprise a processor and a storage unit. The storage unit may be configured to store a code to instruct the processor to perform a source localization process. The processor could be a processing unit, an application processor (AP) or a digital signal processor (DSP), wherein the processing unit could be a central processing unit (CPU), a graphics processing unit (GPU) even a tensor processing unit (TPU), and not limited thereto. The storage unit may be a memory, which may be a non-volatile memory, such as an electrically erasable programmable read-only memory (EEPROM) or a flash memory, and not limited thereto.

Different from the prior art, the sound source localization module 14 may obtain a sound source location according to a received signal received by the microphone array 12, e.g., by a particle swarm optimization (PSO) algorithm.

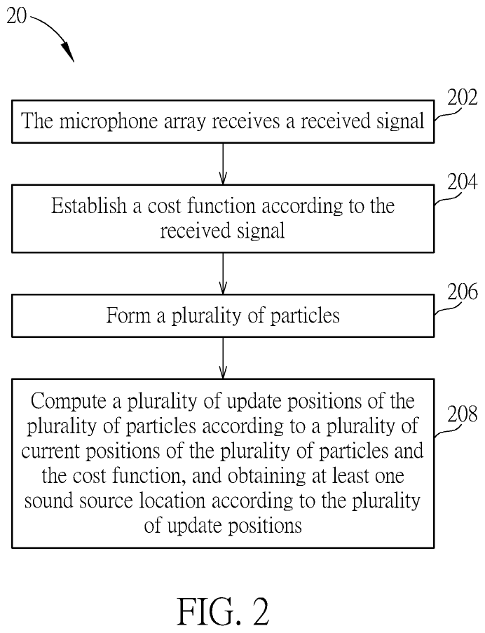

FIG. 2 is a schematic diagram of a sound source localization process 20 according to an embodiment of the present invention. The sound source localization process 20 may be performed by the sound system 10. As shown in FIG. 2, the sound source localization process 20 comprises the following steps:

Step 202: The microphone array receives a received signal.

Step 204: Establish a cost function according to the received signal.

Step 206: Form a plurality of particles.

Step 208: Compute a plurality of update positions of the plurality of particles according to a plurality of current positions of the plurality of particles and the cost function, and obtaining at least one sound source location according to the plurality of update positions.

In Step 202, the microphone array 12 receives a received signal r, wherein received signal r may be expressed as r=[r₁, . . . , r_{M}]^{T} in vector notation, wherein rₘ represents the signal received by the microphone 120_m.

In Step 204, the sound source localization module 14 establishes a cost function CF according to the received signal r. The cost function CF may represent or respond to the reliability of the computation of the sound source location, and there is a monotonous increasing or monotonous decreasing relation between the cost function CF and the reliability of the computation of the sound source location. When the relation between the cost function CF and the reliability of the sound source location is monotonous increasing, the larger cost value corresponding to the cost function CF represents the higher reliability of the computed sound source location.

Methods of establishing the cost function CF are not limited. In an embodiment, the function used within the MUSIC algorithm (notated in S_{MUSIC}) may be applied as the cost function CF in Step 204.

In detail, the sound source localization module 14 may compute a correlation matrix Rᵣᵣ, corresponding to the received signal r and according to the received signal r, as Rᵣᵣ=E[r·r^{H}]. The notation E[⋅] represent the average operation, which may be an ensemble average or a time average in statistics.

After the sound source localization module 14 obtains the correlation matrix Rᵣᵣ, the sound source localization module 14 can perform an eigenvalue decomposition on the correlation matrix Rᵣᵣ, to obtain a plurality of eigenvalues λ₁, . . . , λ_{M} and a plurality of eigenvectors v₁, . . . , v_{M} corresponding to the correlation matrix Rᵣᵣ, wherein λ₁≥ . . . ≥λ_{M} and the eigenvectors v₁, . . . , v_{M} are corresponding to the eigenvalues λ₁, . . . , λ_{M}.

After the sound source localization module 14 obtains the eigenvectors v₁, . . . , v_{M}, the sound source localization module 14 can establish a projection matrix P_{N} corresponding to a noise subspace as

$${P}_{N} = {\sum }_{m = D + 1}^{M} {v}_{m} \cdot {v}_{m}^{H} ,$$

wherein D is the number of sound sources, and M is the number of microphones within the microphone array.

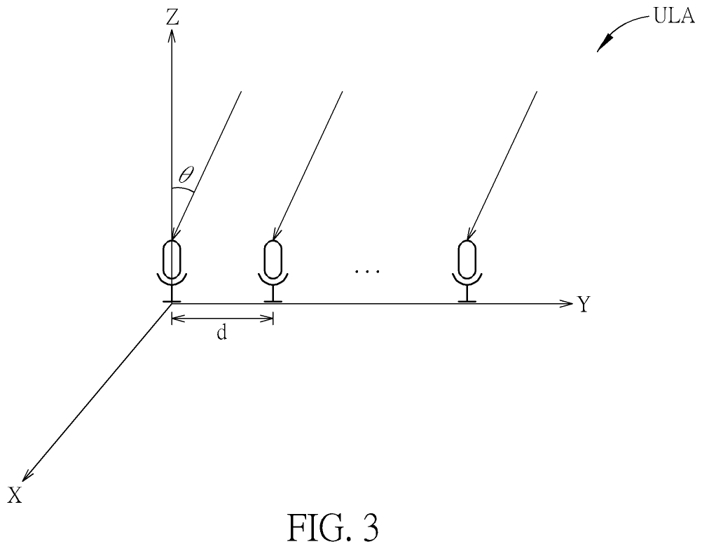

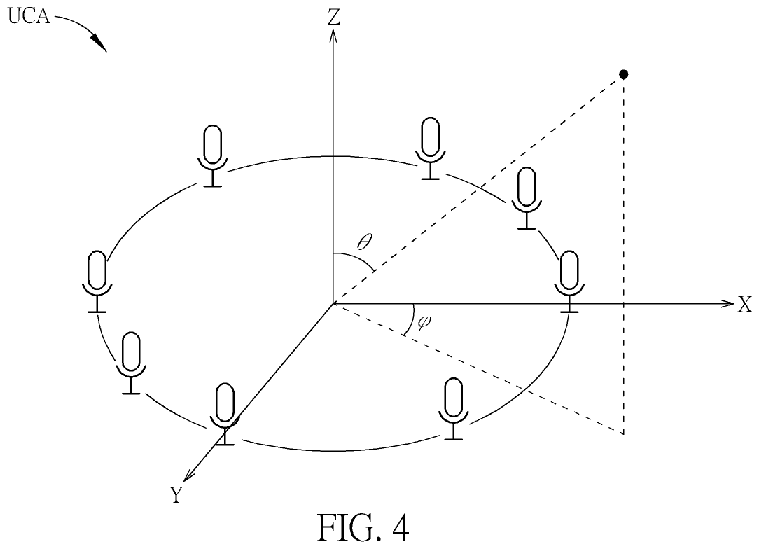

In addition, the sound source localization module 14 can obtain an array manifold vector a corresponding to the microphone array 12 according to the topology of the microphone array 12. For example, if the microphone array 12 is a uniform linear array (ULA) as shown in FIG. 3, then the array manifold vector a may be expressed as a(θ)=[1 e^{j·kcd·sin θ}. . . e^{j·kc·(M-1)·d·sin θ}]^{T}. If the microphone array 12 is a uniform circular array (UCA) as shown in FIG. 4, then the array manifold vector a may be expressed with a(θ, φ)=[e^{j·kc·R·sin θ cos φ}e^{j·kc·R·sin θ cos(φ-2π/M)} . . . e^{j·kc·R·sin θ cos(φ-2π(M-1)/M)}]^{T} wherein d represents the distance between the uniform linear array, R represents a radius of the uniform circular array, θ represents the elevation angle or vertical angle, and φ represents the azimuth angle or horizontal angel. kc represents a wavenumber and can be expressed as kc=2πf/c, where c is the speed of light. Notably, the ULA or UCA is merely for illustrating the array manifold vector a in the above example. In fact, the topology of the microphone array 12 is not limited to be ULA or UCA. The microphone array topology can be designed according to practical situations, and the corresponding array manifold vector a can be obtained further.

After the sound source localization module 14 obtains the array manifold vector a, the sound source localization module 14 can obtain the cost function CF or the function S_{MUSIC} as CF(θ, φ)=S_{MUSIC}(θ, φ)=1/(a^{H}(θ, φ)·P_{N}·a(θ, φ)) according to the projection matrix P_{N} and the array manifold vector a. Due to the fact that the signal subspace is orthogonal to the noise subspace, when (θ_{SS}, φ_{SS}) represents/corresponds to a sound source location SS, a^{H}(θ_{SS}, φ_{SS})·P_{N}·a(θ_{SS}, φ_{SS})=0 and CF(θ_{SS}, φ_{SS})=S_{MUSIC}(θ_{SS}, φ_{SS}) should tend to infinity.

In Step 206, the sound source localization module 14 forms a plurality of particles ptcᵢⱼ, wherein the plurality of particles ptcᵢⱼ are a plurality of virtual particles. In an embodiment, the sound source localization module 14 forms the plurality of virtual particles ptcᵢⱼ in the 2-dimensional space spanned by the elevation angle θ and the azimuth angle φ, and each particle location xᵢⱼ or the virtual particle ptcᵢⱼ is corresponding to an azimuth angle φᵢ and an elevation angle θⱼ, for convenience, the particle locations xᵢⱼ of the particles ptcᵢⱼ can be express as xᵢⱼ=(φᵢ, θⱼ).

In Step 208, the sound source localization module 14 computes the plurality of update positions xᵢⱼ(tₙ₊₁) of the plurality of particles ptcᵢⱼ according to the plurality of current positions xᵢⱼ(tₙ) of the plurality of particles ptcᵢⱼ and the cost function CF, and obtains at least one sound source location according to the plurality of update positions xᵢⱼ(tₙ₊₁).

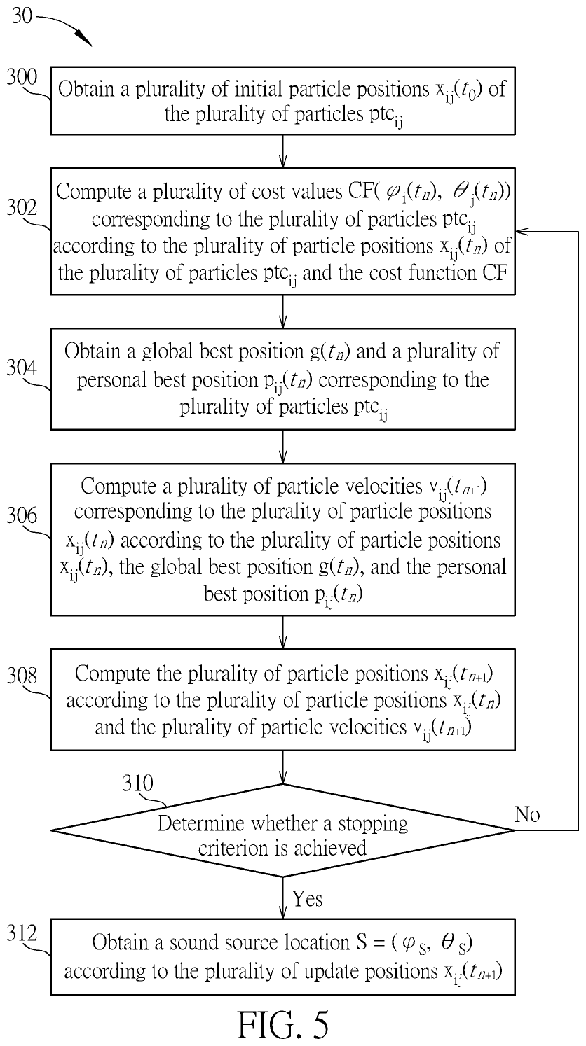

Details of Step 208 can be referred to FIG. 5. FIG. 5 is a schematic diagram of a process 30 according to an embodiment of the present invention. The process 30 is a PSO algorithm. The PSO algorithm is known to one person skilled in the art and described briefly as follows. The process 30 comprises the following steps:

Step 300: Obtain a plurality of initial particle positions xᵢⱼ(t₀) of the plurality of particles ptcᵢⱼ.

Step 302: Compute a plurality of cost values CF(φᵢ(tₙ), θⱼ(tₙ)) corresponding to the plurality of particles ptcᵢⱼ according to the plurality of particle positions xᵢⱼ(tₙ) of the plurality of particles ptcᵢⱼ and the cost function CF.

Step 304: Obtain a global best position g(tₙ) and a plurality of personal best position pᵢⱼ(tₙ) corresponding to the plurality of particles ptcᵢⱼ.

Step 306: Compute a plurality of particle velocities vᵢⱼ(tₙ₊₁) corresponding to the plurality of particle positions xᵢⱼ(tₙ) according to the plurality of particle positions xᵢⱼ(tₙ), the global best position g(tₙ), and the personal best position pᵢⱼ(tₙ).

Step 308: Compute the plurality of particle positions xᵢⱼ(tₙ₊₁) according to the plurality of particle positions xᵢⱼ(tₙ) and the plurality of particle velocities vᵢⱼ(tₙ₊₁).

Step 310: Determine whether a stopping criterion is achieved. If yes, go to Step 312; if not, go to Step 302.

Step 312: Obtain a sound source location S=(φ_{S}, θ_{S}) according to the plurality of update positions xᵢⱼ(tₙ₊₁).

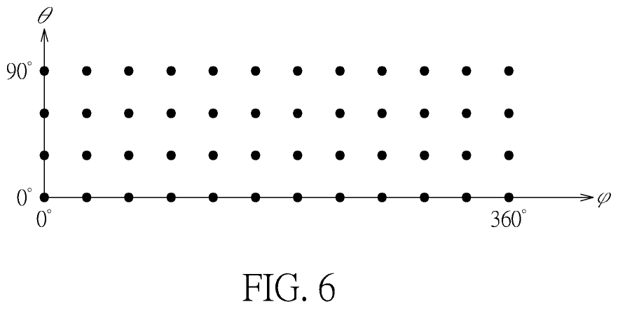

In Step 300, the sound source localization module 14 may distribute the plurality of particle positions xᵢⱼ(t₀) over the 2-dimensional space spanned by the elevation angle θ and the azimuth angle φ. In an embodiment, the sound source localization module 14 may uniformly distribute the plurality of initial particle positions xᵢⱼ(t₀) over the 2-dimensional space spanned by the elevation angle θ and the azimuth angle φ (as shown in FIG. 6), and not limited thereto. For example, if the sound source localization module 14 is able to obtain the (historical) information of the sound source location before executing the process 30, the sound source localization module 14 may distribute the plurality of initial particle positions xᵢⱼ(t₀) to the 2-dimensional space spanned by the elevation angle θ and the azimuth angle φ according to that information.

In Step 302, the sound source localization module 14 may substitute the plurality of particle positions xᵢⱼ(tₙ)=(φᵢ(tₙ), θⱼ(tₙ)) of the plurality of particles ptcᵢⱼ into the cost function CF to compute the plurality of cost values CF(φᵢ(tₙ), θⱼ(tₙ)) corresponding to the plurality of particles ptcᵢⱼ.

In Step 304, the sound source localization module 14 may choose the global best position g(tₙ) according to the plurality of cost values CF(φᵢ(tₙ), θⱼ(tₙ)). In addition, for a specific particles ptcᵢⱼ, the sound source localization module 14 may choose the personal best position pᵢⱼ(tₙ) corresponding to the particles ptcᵢⱼ according to the historical position xᵢⱼ(t₀), . . . , xᵢⱼ(tₙ) of the particles ptcᵢⱼ. The global best position g(tₙ) is the position having (or corresponding to) the cost value CF(φᵢ(tₙ), θⱼ(tₙ)) which is maximum among the ones of the plurality of particle positions xᵢⱼ(tₙ). The personal best position pᵢⱼ(tₙ) corresponding to the particles ptcᵢⱼ is the position having (or corresponding to) the cost value CF(φᵢ(t), θⱼ(t)) among the ones of the historical positions xᵢⱼ(t₀), . . . , xᵢⱼ(tₙ).

In Step 306, the sound source localization module 14 may compute the particle velocity vᵢⱼ(tₙ₊₁) as vᵢⱼ(tₙ₊₁)=w vᵢⱼ(tₙ₊₁)+r1c1(pᵢⱼ(tₙ)−xᵢⱼ(tₙ))+r2c2(g(tₙ)−xᵢⱼ(tₙ)), wherein w is the inertia weight, c1, c2 are the acceleration constants, and r1, r2 are uniform distributed random variables within the interval [0,1]. Moreover, w vᵢⱼ(tₙ₊₁) is the inertia term, (pᵢⱼ(tₙ)−xᵢⱼ(tₙ)) is the cognition term, and (g(tₙ)−xᵢⱼ(tₙ)) is the social term.

In Step 308, the sound source localization module 14 may compute the particle position xᵢⱼ(tₙ₊₁) as xᵢⱼ(tₙ₊₁)=xᵢⱼ(tₙ)+vᵢⱼ(tₙ₊₁).

In Step 310, the sound source localization module 14 determines whether the stopping criterion is achieved. The stopping criterion may be |xᵢⱼ(tₙ₊₁)−xᵢⱼ(tₙ)|<ε or an iteration index n reaching the maximum iteration limit N. If |xᵢⱼ(tₙ₊₁)−xᵢⱼ(tₙ)|<ε or n==N holds, the sound source localization module 14 determines that the stopping criterion is achieved, and the sound source localization module 14 may go to Step 310 to obtain the sound source location S=(φ_{S}, θ_{S}) according to the plurality of update positions xᵢⱼ(tₙ₊₁). Otherwise, the sound source localization module 14 may go back to Step 302 to perform next iteration, including the execution of n=n+1.

For the n-th iteration (corresponding to the time tₙ), the particle position xᵢⱼ(tₙ) may be regarded as the current position of the particles ptcᵢⱼ in Step 302, and the particle position xᵢⱼ(tₙ₊₁) may be regarded as the update positions of the particles ptcᵢⱼ in Step 308.

The process 30 is suitable for the single sound source scenario. Nevertheless, the PSO algorithm may also be applied to the scenario of multiple sound sources.

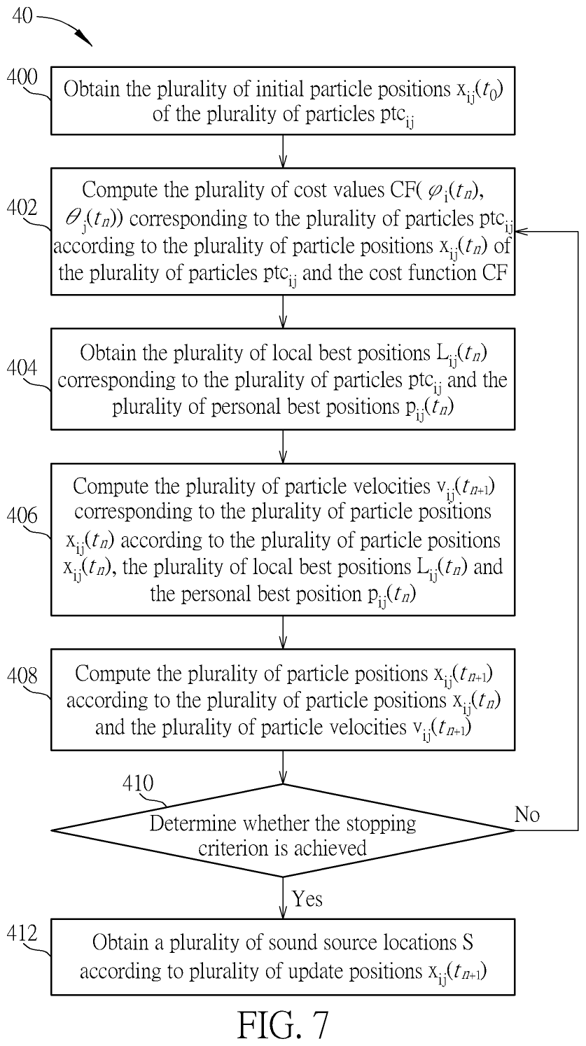

Please refer to FIG. 7, which is a schematic diagram of process 40 according to an embodiment of the present invention. The process 40 is similar to the PSO algorithm and may be applied to the multiple sound sources scenario. The process 40 comprises the following steps:

Step 400: Obtain the plurality of initial particle positions xᵢⱼ(t₀) of the plurality of particles ptcᵢⱼ.

Step 402: Compute the plurality of cost values CF(φᵢ(tₙ), θⱼ(tₙ)) corresponding to the plurality of particles ptcᵢⱼ according to the plurality of particle positions xᵢⱼ(tₙ) of the plurality of particles ptcᵢⱼ and the cost function CF.

Step 404: Obtain the plurality of local best positions Lᵢⱼ(tₙ) corresponding to the plurality of particles ptcᵢⱼ and the plurality of personal best positions pᵢⱼ(tₙ).

Step 406: Compute the plurality of particle velocities vᵢⱼ(tₙ₊₁) corresponding to the plurality of particle positions xᵢⱼ(tₙ) according to the plurality of particle positions xᵢⱼ(tₙ), the plurality of local best positions Lᵢⱼ(tₙ) and the personal best position pᵢⱼ(tₙ).

Step 408: Compute the plurality of particle positions xᵢⱼ(tₙ₊₁) according to the plurality of particle positions xᵢⱼ(tₙ) and the plurality of particle velocities vᵢⱼ(tₙ₊₁).

Step 410: Determine whether the stopping criterion is achieved. If yes, go to Step 412; otherwise, go to Step 402.

Step 412: Obtain a plurality of sound source locations S according to plurality of update positions xᵢⱼ(tₙ₊₁).

The process 40 is similar to the process 30. The difference between the process 40 and process 30 is that, the sound source localization module 14 replaces the global best position g(tₙ) in Step 304 and 306 with the local best positions Lᵢⱼ(tₙ) in Step 404 and 406, to perform the computation of the particle velocities vᵢⱼ(tₙ₊₁).

In Step 404, the sound source localization module 14 forms a region RGᵢⱼ centered at the particles ptcᵢⱼ or the particle positions xᵢⱼ(tₙ), and chooses a plurality of regional particles ptcᵢⱼ^{(RG)} from the plurality of particle positions xᵢⱼ(tₙ) which is in the region RGᵢⱼ. That is, the plurality of regional particle positions xi^{(RG)} corresponding to the plurality of regional particles ptcᵢⱼ^{(RG)} is within RGᵢⱼ.

In an embodiment, the region RGᵢⱼ is a set formed by particle positions with distances related to the particle positions xᵢⱼ(tₙ) being smaller than a parameter a. Generally speaking, the region RGᵢⱼ may be expressed as RGᵢⱼ={x=(φ, θ)|∥x−xᵢⱼ(tₙ)∥≤σ}. ∥·∥ is generally referred to the norm operation. ∥x∥ may be ∥x∥₁, ∥x∥₂ or ∥x∥_{∞}. Norm ∥x∥₁, ∥x∥₂ or ∥x∥_{∞} are known to one skilled in the art and omitted herein for brevity. Moreover, ∥x∥₂ is the Euclidean norm, and the region RGᵢⱼ formed by the Euclidean norm, expressed as RGᵢⱼ={x=(φ, θ)|∥x−xᵢⱼ(tₙ)∥₂≤σ}, is a circle centered at the xᵢⱼ(tₙ) with radius σ.

Moreover, the radius a of the region could be determined according to practical situations or rules of thumb. If two sound sources are too close or the radius a of the region is too large, the location best positions of all particles would point to a sound source with strong energy, which is not good for the sound source separation.

The sound source localization module 14 may compute the plurality of regional cost values CF^{(RG)}(φᵢ(tₙ), θⱼ(tₙ)) corresponding to the plurality of regional particles ptcᵢⱼ^{(RG)} (wherein CF^{(RG)}(φᵢ(tₙ), θⱼ(tₙ))=CF (φᵢ(tₙ), θⱼ(tₙ)), xᵢⱼ^{(RG)}=(φᵢ(tₙ), θⱼ(tₙ))∈RGᵢⱼ), and choose the local best positions Lᵢⱼ(tₙ) corresponding to the particles ptcᵢⱼ according to the plurality of regional cost values CF^{(RG)}(φᵢ(tₙ), θⱼ(tₙ)), wherein the local best position Lᵢⱼ(tₙ) is the position having (or corresponding to) the regional cost value CF^{(RG)}(φᵢ(tₙ), θⱼ(tₙ)) which is maximum among the ones of the plurality of regional particle positions xᵢⱼ^{(RG)}.

In Step 406, the sound source localization module 14 may compute the particle velocities vᵢⱼ(tₙ₊₁) as vᵢⱼ(tₙ₊₁)=w vᵢⱼ(tₙ₊₁)+r1c1(pᵢⱼ(tₙ)−xᵢⱼ(tₙ))+r2c2(Lᵢⱼ (tₙ)−xᵢⱼ(tₙ)).

Other steps in process 40 are the same as the ones in the process 30, which is not narrated herein for brevity.

The processes 30 and 40 are the embodiments to realize Step 208. The process 30 may be applied to single sound source scenario, while the process 40 may be applied to the scenario of multiple sound sources.

In the prior art, the sound source localization using the MUSIC algorithm requires exhaustive search, and the computation complexity is large. In addition, the resolution of the sound source localization depends on the microphone number M of the microphone array. In comparison, the present invention utilizes the PSO algorithm to perform the sound source localization, which does not require too much number of microphones M to achieve accurate sound source localization. In addition, the computation complexity of the PSO algorithm is lower than which of the MUSIC algorithm.

In summary, the present invention utilizes the PSO algorithm to perform sound source localization, which can achieve better accuracy and lower computation complexity.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A sound source localization method, applied to a sound system comprising a microphone array, the method comprising:
the microphone array receiving a received signal;
establishing a cost function according to the received signal;
forming a plurality of particles, wherein the plurality of particles are a plurality of virtual particles; and
computing a plurality of update positions of the plurality of particles according to a plurality of current positions of the plurality of particles and the cost function, and obtaining at least one sound source location according to the plurality of update positions.

2. The sound source localization method of claim 1, wherein the step of establishing the cost function according to the received signal comprises:
establishing a projection matrix corresponding to a noise subspace according to the received signal; and
establishing the cost function according to the projection matrix.

3. The sound source localization method of claim 2, wherein the step of establishing the projection matrix according to the received signal comprises:
computing a correlation matrix according to the received signal;
performing an eigenvalue decomposition on the correlation matrix to obtain a plurality of eigenvalues and a plurality of eigenvectors; and
establishing the projection matrix according to a plurality of first eigenvectors among the plurality of eigenvectors, wherein the plurality of first eigenvectors are corresponding to a plurality of first eigenvalues, a plurality of second eigenvectors among the plurality of eigenvectors are corresponding to a plurality of second eigenvalues, and the plurality of first eigenvalues are all smaller than the plurality of second eigenvalues.

4. The sound source localization method of claim 1, wherein the step of computing the plurality of update positions of the plurality of particles according to the plurality of current positions and the cost function comprises:
computing a plurality of cost values corresponding to the plurality of particles according to the plurality of current positions of the plurality of particles and the cost function;
obtaining a global best position according to the plurality of cost values;
computing a plurality of particle velocities corresponding to the plurality of particles according to the global best position; and
computing the plurality of update positions of the plurality of particles according to the plurality of current positions and the plurality of particle velocities.

5. The sound source localization method of claim 1, wherein the step of computing the plurality of update positions of the plurality of particles according to the plurality of current positions and the cost function comprises:
computing a plurality of cost values corresponding to the plurality of particles according to the plurality of current positions of the plurality of particles and the cost function;
obtaining a global best position according to the plurality of cost values;
obtaining a plurality of first historical positions which a first particle of the plurality of particles has experienced;
computing a plurality of first historical cost values corresponding to the plurality of first historical positions according to the plurality of first historical positions and the cost function;
obtaining a first personal best position corresponding to the first particle according to the plurality of first historical cost values;
computing a first particle velocity corresponding to the first particle according to the global best position and the first personal best position; and
computing a first update position corresponding to the first particle according to a first current position corresponding to the first particle and the first particle velocity.

6. The sound source localization method of claim 1, wherein the step of computing the plurality of update positions of the plurality of particles according to the plurality of current positions and the cost function comprises:
obtaining a plurality of first regional particles within a first region from the plurality of particles, wherein the first region is centered at a first particle of the plurality of particles;
computing a plurality of first regional cost values corresponding to the plurality of first regional particles according to a plurality of first current positions of the plurality of first regional particles and the cost function;
obtaining a first local best position corresponding to the first particle according to the plurality of first regional cost values;
computing a first particle velocity corresponding to the first particle according to the first local best position; and
computing a first update position corresponding to the first particle according to a first current position corresponding to the first particle and the first particle velocity.

7. The sound source localization method of claim 1, wherein the step of computing the plurality of update positions of the plurality of particles according to the plurality of current positions and the cost function comprises:
obtaining a plurality of first regional particles within a first region from the plurality of particles, wherein the first region is centered at a first particle of the plurality of particles;
computing a plurality of first regional cost values corresponding to the plurality of first regional particles according to a plurality of current positions of the plurality of first regional particles and the cost function;
obtaining a first local best position corresponding to the first particle according to the plurality of first regional cost values;
obtaining a plurality of first historical positions which a first particle of the plurality of particles has experienced;
computing a plurality of first historical cost values corresponding to the plurality of first historical positions according to the plurality of first historical positions and the cost function;
obtaining a first personal best position corresponding to the first particle according to the plurality of first historical cost values;
computing a first particle velocity corresponding to the first particle according to the first local best position and the first personal best position; and
computing a first update position corresponding to the first particle according to a first current position corresponding to the first particle and the first particle velocity.

8. The sound source localization method of claim 1, wherein the step of computing the plurality of update positions according to the plurality of particles to the plurality of current positions and the cost function and obtaining the at least one sound source location according to the plurality of update positions comprises:
obtaining a plurality of regions corresponding to the plurality of particles, wherein the plurality of regions are respectively centered at the plurality of particles;
obtaining a plurality of local best positions corresponding to the plurality of particles according to the plurality of regions and the cost function;
computing a plurality of particle velocities corresponding to the plurality of particles according to the plurality of local best positions;
computing the plurality of update positions of the plurality of particles according to the plurality of current positions and the plurality of particle velocities; and
obtaining a plurality of sound source locations according to the plurality of update positions.

9. The sound source localization method of claim 1, wherein the step of computing the plurality of update positions according to the plurality of current positions and the cost function and obtaining the at least one sound source location according to the plurality of update positions comprises:
obtaining a plurality of regions corresponding to the plurality of particles, wherein the plurality of regions are respectively centered at the plurality of particles;
obtaining a plurality of local best positions corresponding to the plurality of particles according to the plurality of regions and the cost function;
obtaining a plurality of personal best positions corresponding to the plurality of particles according to the cost function and a plurality of historical positions which the plurality of particles have experienced;
computing a plurality of particle velocities corresponding to the plurality of particles according to the plurality of local best positions and the plurality of personal best positions;
computing the plurality of update positions of the plurality of particles according to the plurality of current positions and the plurality of particle velocities; and
obtaining a plurality of sound source locations according to the plurality of update positions.

10. A sound system, comprising:
a microphone array, comprising a plurality of microphone, configured to receive a received signal; and
a sound source localization module, configured to perform the following steps:
establishing a cost function according to the received signal;
forming a plurality of particles, wherein the plurality of particles are a plurality of virtual particles; and
computing a plurality of update positions of the plurality of particles according to a plurality of current positions of the plurality of particles and the cost function, and obtaining at least one sound source location according to the plurality of update positions.

11. The sound system of claim 10, wherein the step of establishing the cost function according to the received signal comprises:
establishing a projection matrix corresponding to a noise subspace according to the received signal; and
establishing the cost function according to the projection matrix.

12. The sound system of claim 11, wherein the step of establishing the projection matrix according to the received signal comprises:
computing a correlation matrix according to the received signal;
performing an eigenvalue decomposition on the correlation matrix to obtain a plurality of eigenvalues and a plurality of eigenvectors; and
establishing the projection matrix according to a plurality of first eigenvectors among the plurality of eigenvectors, wherein the plurality of first eigenvectors are corresponding to a plurality of first eigenvalues, a plurality of second eigenvectors among the plurality of eigenvectors are corresponding to a plurality of second eigenvalues, and the plurality of first eigenvalues are all smaller than the plurality of second eigenvalues.

13. The sound system of claim 10, wherein the step of computing the plurality of update positions of the plurality of particles according to the plurality of current positions and the cost function comprises:
computing a plurality of cost values corresponding to the plurality of particles according to the plurality of current positions of the plurality of particles and the cost function;
obtaining a global best position according to the plurality of cost values;
computing a plurality of particle velocities corresponding to the plurality of particles according to the global best position; and
computing the plurality of update positions of the plurality of particles according to the plurality of current positions and the plurality of particle velocities.

14. The sound system of claim 10, wherein the step of computing the plurality of update positions of the plurality of particles according to the plurality of current positions and the cost function comprises:
computing a plurality of cost values corresponding to the plurality of particles according to the plurality of current positions of the plurality of particles and the cost function;
obtaining a global best position according to the plurality of cost values;
obtaining a plurality of first historical positions which a first particle of the plurality of particles has experienced;
computing a plurality of first historical cost values corresponding to the plurality of first historical positions according to the plurality of first historical positions and the cost function;
obtaining a first personal best position corresponding to the first particle according to the plurality of first historical cost values;
computing a first particle velocity corresponding to the first particle according to the global best position and the first personal best position; and
computing a first update position corresponding to the first particle according to a first current position corresponding to the first particle and the first particle velocity.

15. The sound system of claim 10, wherein the step of computing the plurality of update positions of the plurality of particles according to the plurality of current positions and the cost function comprises:
obtaining a plurality of first regional particles within a first region from the plurality of particles, wherein the first region is centered at a first particle of the plurality of particles;
computing a plurality of first regional cost values corresponding to the plurality of first regional particles according to a plurality of first current positions of the plurality of first regional particles and the cost function;
obtaining a first local best position corresponding to the first particle according to the plurality of first regional cost values;
computing a first particle velocity corresponding to the first particle according to the first local best position; and
computing a first update position corresponding to the first particle according to a first current position corresponding to the first particle and the first particle velocity.

16. The sound system of claim 10, wherein the step of computing the plurality of update positions of the plurality of particles according to the plurality of current positions and the cost function comprises:
obtaining a plurality of first regional particles within a first region from the plurality of particles, wherein the first region is centered at a first particle of the plurality of particles;
computing a plurality of first regional cost values corresponding to the plurality of first regional particles according to a plurality of first current positions of the plurality of first regional particles and the cost function;
obtaining a first local best position corresponding to the first particle according to the plurality of first regional cost values;
obtaining a plurality of first historical positions which a first particle of the plurality of particles has experienced;
computing a plurality of first historical cost values corresponding to the plurality of first historical positions according to the plurality of first historical positions and the cost function;
obtaining a first personal best position corresponding to the first particle according to the plurality of first historical cost values;
computing a first particle velocity corresponding to the first particle according to the first local best position and the first personal best position; and
computing a first update position corresponding to the first particle according to a first current position corresponding to the first particle and the first particle velocity.

17. The sound system of claim 10, wherein the step of computing the plurality of update positions according to the plurality of particles to the plurality of current positions and the cost function and obtaining the at least one sound source location according to the plurality of update positions comprises:
obtaining a plurality of regions corresponding to the plurality of particles, wherein the plurality of regions are respectively centered at the plurality of particles;
obtaining a plurality of local best positions corresponding to the plurality of particles according to the plurality of regions and the cost function;
computing a plurality of particle velocities corresponding to the plurality of particles according to the plurality of local best positions;
computing the plurality of update positions of the plurality of particles according to the plurality of current positions and the plurality of particle velocities; and
obtaining a plurality of sound source locations according to the plurality of update positions.

18. The sound system of claim 10, wherein the step of computing the plurality of update positions according to the plurality of current positions and the cost function and obtaining the at least one sound source location according to the plurality of update positions comprises:
obtaining a plurality of regions corresponding to the plurality of particles, wherein the plurality of regions are respectively centered at the plurality of particles;
obtaining a plurality of local best positions corresponding to the plurality of particles according to the plurality of regions and the cost function;
obtaining a plurality of personal best positions corresponding to the plurality of particles according to the cost function and a plurality of historical positions which the plurality of particles have experienced;
computing a plurality of particle velocities corresponding to the plurality of particles according to the plurality of local best positions and the plurality of personal best positions;
computing the plurality of update positions of the plurality of particles according to the plurality of current positions and the plurality of particle velocities; and
obtaining a plurality of sound source locations according to the plurality of update positions.

19. The sound system of claim 1, wherein each of the particles is corresponding to an azimuth angle.

20. The sound system of claim 1, wherein each of the particles is corresponding to an azimuth angle and an elevation angle.
